(19) United States
(12) Patent Application Publication
(10) Pub. No.: US 2025/0232262 A1
(43) Pub. Date: Jul. 17, 2025

(54) Automated Talent Acquisition and Management System Using AI

(71) Applicant: Adam Jackson, Las Vegas, NV (US)

(72) Inventor: Adam Jackson, Las Vegas, NV (US)

(21) Appl. No.: 18/972,322

(22) Filed: Dec. 6, 2024

Related U.S. Application Data
(60) Provisional application No. 63/620,970, filed on Jan. 15, 2024.

(51) Int. Cl. G06Q 10/1053; G06Q 10/0631

(52) U.S. Cl. CPC G06Q 10/1053; G06Q 10/063112

(57) ABSTRACT

A talent recruitment system includes architecture having a first AI module for generating a job description wherein the first AI module leverages a Large Language Model trained on a proprietary dataset of successful job descriptions. The talent recruitment system includes a sourcing module for automated candidate sourcing wherein the sourcing module includes use of an AI-driven engine leveraging a global database of candidate profiles. The talent recruitment system includes a screening module for AI-Enhanced resume screening wherein the screening module screens and ranks resumes by applying consistent criteria in relation to the job requirements.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### CROSS-REFERENCE TO RELATED APPLICATIONS

This application is a Utility Patent application claiming priority to U.S. Provisional Patent Application Ser. No. 63/620,970, filed on Jan. 15, 2024, which is incorporated by reference herein in its entirety.

### BACKGROUND OF THE INVENTION

### 1. Field of the Invention

The present disclosure generally relates to systems and methods for automated talent acquisition and management using artificial intelligence and machine learning to ingest data, generate job descriptions, source candidates, screen resumes, conduct interviews, match candidates to jobs, and manage payment of employees and contractors.

### 2. Description of Related Art

In the modern business world, talent acquisition and management are integral parts of a company's operations. These processes involve sourcing, recruiting, interviewing, hiring, and managing employees and contractors. Traditionally, these tasks have been performed manually by human resources personnel, which can be time-consuming and costly.

With the advent of technology, various systems have been developed to automate some aspects of these processes. For instance, there are systems that can post job advertisements, collect resumes, and even screen candidates based on predefined criteria. These systems have greatly improved the efficiency of talent acquisition and management.

Artificial Intelligence (AI) and Machine Learning (ML) are technologies that have been increasingly applied in various fields, including talent acquisition and management. AI involves the simulation of human intelligence processes by machines, especially computer systems. These processes include learning, reasoning, problem-solving, perception, and language understanding. On the other hand, Machine Learning is a type of AI that provides systems the ability to automatically learn and improve from experience without being explicitly programmed.

AI and ML can be used to analyze large amounts of data and make predictions or decisions without human intervention. In the context of talent acquisition and management, AI and ML can be used to analyze data about companies and candidates, generate job descriptions, source candidates, screen resumes, conduct interviews, match candidates to jobs, and manage payment of employees and contractors.

Despite the advancements in technology, the process of talent acquisition and management still poses challenges. For instance, the process of sourcing and recruiting candidates can be time-consuming and costly. Additionally, the process of interviewing candidates and matching them to jobs requires a deep understanding of the company's requirements and the candidate's qualifications, which can be difficult to achieve with traditional systems.

### SUMMARY OF THE INVENTION

In a first aspect, the system features an artificial intelligence (AI) agent having the capability to ingest data sets about companies and candidates. The AI agent is also capable of generating custom job descriptions based on the ingested data about a company. Furthermore, the AI agent can source candidates for a new job based on the generated job descriptions. The AI agent is also configured to screen resumes, profiles, conduct live interviews, and build candidate scorecards. The system also includes an AI matching system that can match candidates to jobs based on hundreds of input parameters. Additionally, the system has a software system that manages paying employees and contractors.

The system may include one or more of the following features. The AI agent that ingests data sets about companies and candidates may also learn and adapt based on the ingested data. The AI agent that generates custom job descriptions may also update the job descriptions based on changes in the company's requirements. The AI agent that sources candidates for a new job may source candidates from multiple platforms. The AI agent that screens resumes, profiles, conducts live interviews, and builds candidate scorecards may provide real-time feedback to the candidates. The AI matching system that matches candidates to jobs may provide a ranking of the candidates based on the match. The software system that manages paying employees and contractors may handle tax and benefits calculations.

In a second aspect, the method features using an AI agent to ingest data sets about companies and candidates, generate custom job descriptions based on the ingested data about a company, source candidates for a new job based on the generated job descriptions, screen resumes, profiles, conduct live interviews, and build candidate scorecards. The method also includes using an AI matching system to match candidates to jobs based on hundreds of input parameters, and using a software system to manage paying employees and contractors.

The method may include one or more of the following features. The AI agent may learn and adapt based on the ingested data. The AI agent may update the job descriptions based on changes in the company's requirements. The AI agent may source candidates from multiple platforms. The AI agent may provide real-time feedback to the candidates during the live interviews. The AI matching system may provide a ranking of the candidates based on the match. The software system may handle tax and benefits calculations for the employees and contractors.

Still other objects and advantages of the invention will in part be obvious and will in part be apparent from the specification.

The above and other objects, which will be apparent to those skilled in the art, are achieved in the present invention which is directed to an automated talent acquisition and management system. The system includes an artificial intelligence (AI) ingesting agent for ingesting data sets about companies and candidates. The system includes an AI description agent for generating custom job descriptions based on the ingested data about a company, an AI sourcing agent for sourcing candidates for a new job based on the generated job descriptions and an AI screening agent configured to screen resumes, profiles, conduct live interviews, and build candidate scorecards. The system includes an AI matching system for matching candidates to jobs based on hundreds of input parameters and a software system configured to manage paying employees and contractors. The AI agent ingests data sets about companies and candidates, learns and adapts based on the ingested data and generates custom job descriptions. The AI agent updates the job descriptions based on changes in the company's requirements. The AI agent sources candidates for a new job and sources candidates from multiple platforms and to screen resumes, profiles, conduct live interviews, and build candidate scorecards is further configured to provide real-time feedback to the candidates. The AI matching system is configured to match candidates to jobs and to provide a ranking of the candidates based on the match. The software system manages paying employees and contractors is further configured to handle tax and benefits calculations.

In one embodiment, a talent recruitment system includes architecture having a first AI module for generating a job description wherein the first AI module leverages a he talent recruitment system includes a sourcing module for automated candidate sourcing wherein the sourcing module includes use of an AI-driven engine leveraging a global database of candidate profiles. The talent recruitment system includes a screening module for AI-Enhanced resume screening wherein the screening module screens and ranks resumes by applying consistent criteria in relation to the job requirements.

The first AI module has been benchmarked through evaluation metrics analysis on historical job descriptions and human grading to ensure the relevance and accuracy of the generated job postings and by utilizing historical offer data, the system suggests rates that align with market trends, considering factors such as location, role, years of experience, and skill.

The sourcing module may apply a hybrid filtering approach, combining rule-based systems with machine learning classifiers wherein the AI-driven engine ranks candidates according to their alignment with the job description, considering factors such as skills, experience, and previous job performance resulting in a significant reduction in the time needed to identify suitable candidates.

The screening and ranking of resumes may apply consistent criteria in relation to the job requirements using a combination of keyword analysis, semantic matching, and machine learning to evaluate the relevance of a profile of each candidate.

The clients may receive a match label indicating a great or poor fit and receive a concise summary in natural language, outlining the key factors that contribute to the candidate's suitability for the role wherein the system ensures that the most qualified candidates are prioritized, reducing the potential for human bias and improving the overall quality of hires.

The system may perform synchronous live video interviews or live audio interviews, the system including an interview module using a large language model trained with proprietary data from the a marketplace using the system, the system actively understanding and interacting with the applicant in real-time, wherein the marketplace large language model processes responses of the applicant, assesses relevance and depth, and formulates follow-up questions dynamically, wherein the interaction between the applicant and the interview module allows the system to focus on specific areas of expertise of the candidate, ensuring a comprehensive evaluation of the applicant capabilities and wherein the line of questioning is continuously adjusted based on the applicant answers, enabling a thorough assessment of their skills, experience, and fit for the role. The system may ensure every candidate is assessed comprehensively, reducing the risk of overlooking critical competencies and providing hiring. The system may include use of managers with a detailed and nuanced profile of each candidate. The data-driven insights may include detailed analytics on various aspects of the recruitment process, including the applicant's skills, work history, and alignment with the client's role requirements. It collects and analyzes data such as applicant Skills: including specific technical and soft skills of candidates, derived from their resumes, profiles, and interview responses. The data-driven insights may include work history including the applicant's previous roles, duration of employment, and career progression, providing insights into their experience and suitability for the position. The data-driven insights may include client requirements including specific qualifications, skills, and experience required by the client for the role, ensuring that candidates are matched with positions that align with their expertise. The insights may help organizations refine their hiring strategies, optimize role descriptions, and make more informed decisions, ultimately improving the overall efficiency and effectiveness of the recruitment process.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a diagram showing a first embodiment of a talent recruitment system;

FIG. 2 is a diagram showing a second embodiment of a talent recruitment system;

FIG. 3 is a diagram showing a third embodiment of a talent recruitment system;

FIG. 4 is a slide comparing the present system to prior methods of hiring;

FIG. 5 is a slide showing the first steps in using the system according to the present invention;

FIG. 6 is a slide showing the step of matching of candidates using the system;

FIG. 7 is a slide showing the step of interviewing the talent using the system;

FIG. 8 is a slide showing the generation of offers using the system; and

FIG. 9 is a slide showing an overall view of the system.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

Prior to a discussion of the preferred embodiment of the invention, it should be understood that the features and advantages of the invention are illustrated in terms of a system that saves companies significant time and money in the area of sourcing, recruiting, interviewing, hiring and managing/paying workers.

The system uses machine learning, AI and large language models to learn about companies and candidates then match them together. Features include AI agents that ingest rich data sets about companies and candidates, AI agents that can write job descriptions, AI agents that screen and live interview candidates, an AI system that matches candidates to jobs and software systems that manage paying employees and contractors.

Features include:
AI agents that create custom job descriptions based on deep knowledge of a company AI agents that source candidates for a new job
AI agents that screen resumes, profiles and conduct live interviews and build candidate scorecards
AI matching system that matches candidates to jobs based on hundreds of input parameters”

The present invention is a system for transforming hiring to remove 95% of the time, cost, and effort to hire top talent. The system saves companies significant time and money in the area of sourcing, recruiting, interviewing, hiring and managing/paying workers. The system uses machine learning, AI and large language models to learn about companies and candidates then match them together. Features include AI agents that ingest rich data sets about companies and candidates, AI agents that can write job descriptions, AI agents that screen and live interview candidates, an AI system that matches candidates to jobs and software systems that manage paying employees and contractors.

The present disclosure provides an automated talent acquisition and management system. This system is designed to streamline and automate various aspects of talent acquisition and management, which traditionally have been manual and time-consuming processes. The system leverages artificial intelligence (AI) and machine learning technologies to perform tasks such as ingesting data sets about companies and candidates, generating custom job descriptions, sourcing candidates, screening resumes and profiles, conducting live interviews, building candidate scorecards, matching candidates to jobs, and managing the payment of employees and contractors.

The system includes an AI agent that is configured to ingest data sets about companies and candidates. This AI agent is capable of learning and adapting based on the ingested data, thereby improving its performance over time. The ingested data can include a wide range of information about the companies and candidates, such as the company's industry, size, culture, job requirements, and the candidate's skills, experience, qualifications, and preferences.

Another AI agent in the system is configured to generate custom job descriptions based on the ingested data about a company. This AI agent can create job descriptions that accurately reflect the company's requirements and culture, thereby attracting suitable candidates. The job descriptions can be updated by the AI agent based on changes in the company's requirements.

The system also includes an AI agent that is configured to source candidates for a new job based on the generated job descriptions. This AI agent can source candidates from multiple platforms, such as job boards, social media, professional networks, and the company's own database of candidates. The AI agent can use the job descriptions as a guide to identify candidates who are likely to be a good fit for the job.

Another AI agent in the system is configured to screen resumes, profiles, conduct live interviews, and build candidate scorecards. This AI agent can analyze the resumes and profiles of the sourced candidates, conduct live interviews using natural language processing techniques, and build scorecards that evaluate the candidates based on various criteria. The AI agent can provide real-time feedback to the candidates during the live interviews, thereby enhancing the candidate experience.

The system further includes an AI matching system that is configured to match candidates to jobs based on hundreds of input parameters. This AI matching system can analyze the candidate scorecards and the job descriptions, and match the candidates to the jobs based on a comprehensive set of parameters. The AI matching system can provide a ranking of the candidates based on the match, thereby assisting the company in making informed hiring decisions.

Finally, the system includes a software system that is configured to manage paying employees and contractors. This software system can handle various aspects of employee and contractor payment, such as salary calculation, tax calculation, benefits calculation, and payment processing. The software system can automate these tasks, thereby reducing the administrative burden on the company.

One of the integral components of the system is an AI agent that is specifically configured to ingest data sets about companies and candidates. This AI agent is designed to process a wide array of information about both the companies and the candidates. For companies, the data can include, but is not limited to, the company's industry, size, culture, and specific job requirements. For candidates, the data can encompass their skills, experience, qualifications, and preferences. The data also includes recorded video interviews between the AI agent and the candidate. This comprehensive data ingestion allows the AI agent to have a deep understanding of both the companies' requirements and the candidates' capabilities, as well as a probability of success for the candidate in that specific role with the company

Furthermore, this AI agent is not just a passive data processor. It is designed with the capability to learn and adapt based on the ingested data. This learning and adaptation are facilitated through machine learning algorithms that enable the AI agent to improve its performance over time. As the AI agent processes more data, it can refine its understanding of the companies and candidates, and improve its ability to match them effectively. This learning and adaptation capability allows the AI agent to stay updated with changes in the job market, company requirements, and candidate qualifications, thereby ensuring that the system remains effective and efficient in the long run.

Another integral component of the system is an AI agent that is configured to generate custom job descriptions based on the ingested data about a company. This AI agent utilizes the data ingested about the company, which may include the company's industry, size, culture, and specific job requirements, to create job descriptions that accurately reflect the company's requirements and culture. This process is not merely a simple translation of the ingested data into a job description format. Instead, the AI agent uses machine learning algorithms to understand the nuances of the company's requirements and culture, and then generates job descriptions that capture these nuances. This results in job descriptions that are tailored to the company, thereby attracting candidates who are likely to be a good fit for the company.

Furthermore, this AI agent is not static in its operation. It is designed with the capability to update the job descriptions based on changes in the company's requirements. This updating process is facilitated by the AI agent's learning and adaptation capabilities. As the AI agent ingests more data about the company, it can detect changes in the company's requirements. Upon detecting such changes, the AI agent can update the job descriptions to reflect the new requirements. This ensures that the job descriptions remain accurate and relevant, even as the company's requirements evolve over time. This dynamic updating capability of the AI agent contributes to the system's overall effectiveness and efficiency in talent acquisition and management.

Another component of the system is an AI agent that is configured to source candidates for a new job based on the generated job descriptions. This AI agent operates by using the job descriptions as a guide to identify potential candidates who are likely to be a good fit for the job. The sourcing process is not a simple keyword matching operation. Instead, the AI agent uses advanced machine learning algorithms to understand the nuances of the job descriptions and identify candidates who not just meet the basic requirements of the job, but also align with the company's culture and values as well as the candidate's “hard” and “soft” skills, language proficiency, personality type and other factors gleaned from equal agent to candidate interaction ratio via text, audio or video.

Furthermore, the AI agent is designed with the capability to source candidates from multiple platforms. These platforms can include job boards, social media sites, professional networks, and the company's own database of candidates. By sourcing candidates from multiple platforms, the AI agent can access a wider pool of candidates, thereby increasing the chances of finding the right candidate for the job. This multi-platform sourcing capability of the AI agent contributes to the system's overall effectiveness and efficiency in talent acquisition and management.

Another integral component of the system is an AI agent that is configured to screen resumes, profiles, conduct live interviews, and build candidate scorecards. This AI agent operates by analyzing the resumes and profiles of the sourced candidates, conducting live interviews using natural language processing techniques, and building scorecards that evaluate the candidates based on various criteria. The criteria can include, but are not limited to, the candidate's skills, experience, qualifications, and alignment with the company's culture and values. This comprehensive screening process allows the AI agent to identify candidates who are not just qualified for the job, but also a good fit for the company.

Furthermore, this AI agent is not just a passive screener. It is designed with the capability to provide real-time feedback to the candidates during the live interviews. This real-time feedback can include, but is not limited to, clarifications on the candidate's responses, suggestions for improvement, and immediate evaluation of the candidate's performance. This real-time feedback enhances the candidate experience by providing them with immediate and constructive feedback, thereby helping them improve their performance in future interviews. This real-time feedback capability of the AI agent contributes to the system's overall effectiveness and efficiency in talent acquisition and management.

Another integral component of the system is an AI matching system that is configured to match candidates to jobs based on hundreds of input parameters. This AI matching system operates by analyzing the candidate scorecards and the job descriptions, and matching the candidates to the jobs based on a comprehensive set of parameters. These parameters can include, but are not limited to, the candidate's skills, experience, qualifications, and alignment with the company's culture and values, as well as the job's requirements, responsibilities, and benefits. This comprehensive matching process allows the AI matching system to identify candidates who are not just qualified for the job, but also a good fit for the company.

Furthermore, this AI matching system is not just a passive matcher. It is designed with the capability to provide a ranking of the candidates based on the match. This ranking process is facilitated by advanced machine learning algorithms that evaluate the match between the candidates and the job based on the comprehensive set of parameters. The AI matching system can generate a ranking of the candidates, with the top-ranked candidates being those who are the closest match to the job. This ranking provides the company with a prioritized list of candidates, thereby assisting the company in making informed hiring decisions. This ranking capability of the AI matching system contributes to the system's overall effectiveness and efficiency in talent acquisition and management.

Another integral component of the system is a software system that is configured to manage the payment of employees and contractors. This software system is designed to handle various aspects of employee and contractor payment, such as salary calculation, tax calculation, benefits calculation, and payment processing. The software system can automate these tasks, thereby reducing the administrative burden on the company and ensuring accurate and timely payment to the employees and contractors.

Furthermore, this software system is not just a passive payment processor. It is designed with the capability to handle tax and benefits calculations for the employees and contractors. This capability is facilitated by advanced algorithms that can calculate the appropriate tax and benefits based on various parameters, such as the employee's or contractor's salary, location, and employment status. The software system can automatically calculate the tax and benefits, thereby ensuring compliance with tax laws and benefits policies. This tax and benefits calculation capability of the software system contributes to the system's overall effectiveness and efficiency in talent acquisition and management.

The system has architecture including an AI generated job description module which leverages a Large Language Model trained on a proprietary dataset of successful job descriptions and has been benchmarked through evaluation metrics analysis on historical job descriptions and human grading to ensure the relevance and accuracy of the generated job postings. By utilizing historical offer data, the system suggests rates that align with market trends, considering factors such as location, role, years of experience, and skill.

A sourcing engine leverages a global database of candidate profiles and applies a hybrid filtering approach, combining rule-based systems with machine learning classifiers. The AI-driven engine ranks candidates according to their alignment with the job description, considering factors such as skills, experience, and previous job performance. The result is a significant reduction in the time needed to identify suitable candidates.

An AI-enhanced resume screening module automates the screening and ranking of resumes by applying consistent criteria based on the job requirements. It uses a combination of keyword analysis, semantic matching, and machine learning to evaluate the relevance of each candidate's profile. In addition to the match label indicating a great or poor fit, clients receive a concise summary in natural language, outlining the key factors that contribute to the candidate's suitability for the role. The system ensures that the most qualified candidates are prioritized, reducing the potential for human bias and improving the overall quality of hires.

The interview module utilizes a large language model (LLM) trained with proprietary data from the Braintrust marketplace for synchronous, live video or audio interviews.

Unlike conventional interview methods, the system actively understands and interacts with the applicant in real-time. The LLM processes the applicant's responses, assesses their relevance and depth, and formulates follow-up questions on the spot. This dynamic interaction allows the system to delve deeper into specific areas of the candidate's expertise, ensuring a comprehensive evaluation of their capabilities. The line of questioning is continuously adjusted based on the applicant's answers, enabling a thorough assessment of their skills, experience, and fit for the role.

Benefit: This innovative approach results in a highly accurate and objective evaluation process. The live, AI-powered interview ensures that every candidate is assessed comprehensively, reducing the risk of overlooking critical competencies. This level of interaction and understanding surpasses simple automated interviews, providing hiring managers with a detailed and nuanced profile of each candidate.

Data-driven insights help the system provide detailed analytics on various aspects of the recruitment process, including the applicant's skills, work history, and alignment with the client's role requirements. It collects and analyzes data such as applicant skills, work history and client requirements. The specific technical and soft skills of candidates, derived from their resumes, profiles, and interview responses. The applicant's previous roles, duration of employment, and career progression, providing insights into their experience and suitability for the position. The specific qualifications, skills, and experience required by the client for the role, ensuring that candidates are matched with positions that align with their expertise.

The data-driven insights help organizations refine their hiring strategies, optimize role descriptions, and make more informed decisions, ultimately improving the overall efficiency and effectiveness of the recruitment process.

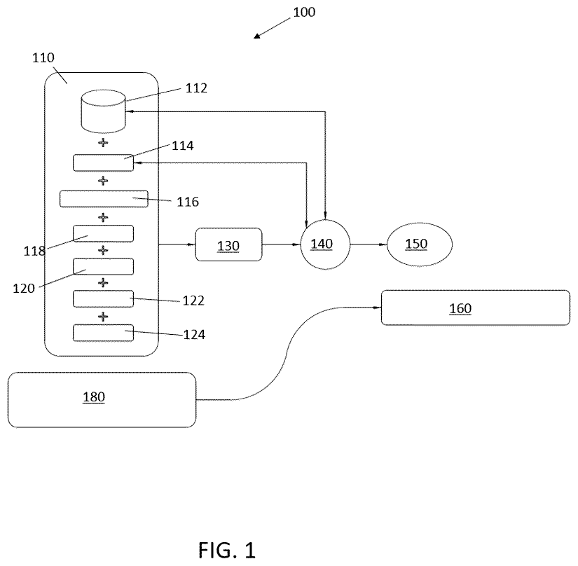

Referring now to the drawings FIGS. 1-9, and more particularly to FIG. 1 there is a diagram showing an embodiment of the talent acquisition system.

An AI-powered interviewing system 100 is a component of the AI Recruiter (AIR) platform. The system 100 processes various inputs to conduct dynamic, context-aware interviews. Input components are included in the system which integrates multiple data sources and parameters including call metadata 112 which stores information about the interview call, chat history 114 which maintains a record of the conversation, new response from talent 116 which captures the latest input from the interviewee, job requirement 118 which contains specific criteria for the position, talent background 120 which includes the candidate's professional and educational history, interview questions 122 which include a repository of potential questions to ask, and interview setup 124 which includes parameters defining the structure and goals of the interview.

The system utilizes an embedding model 140 to identify previously asked question, log the remaining time for the entire interview and track time allocation for each question. The embedding model 140 ensures efficient time management and prevents redundancy in questioning. In conversation processing two key processes occur before the main AI processing. Conversation chaining organizes the flow of the conversation. The chat history is trimmed and summarized to maintain relevance and manage the input size. An LLM, which is preferably an AIR LLM, processes all inputs from the various components, generates appropriate responses and questions based on the context, and utilizes the embedded information about previous questions and timing. For response generation, the LLM produces a response from AIR 150 which is an output of the system. The output includes follow-up questions to the candidate, assessments of the candidate responses, and directions for the next phase of the interview. An applicant response 180 is a talent response such as “I used modular test and page object patterns to keep the automated test code organized and easier to update.” AIR's follow-up 160 may be “Excellent approach! How did you measure and improve the performance of your automated tests over time?” The example of the applicant response 180 and AIR follow up 160 demonstrates the ability of the system to understand technical responses and ask relevant, probing follow-up questions.

The system adapts dynamically to the conversation flow, considering the candidate's background and responses, the specific job requirements, and the predefined interview structure and goals. The AI Interviewer system is used for initial screening interviews and technical assessments.

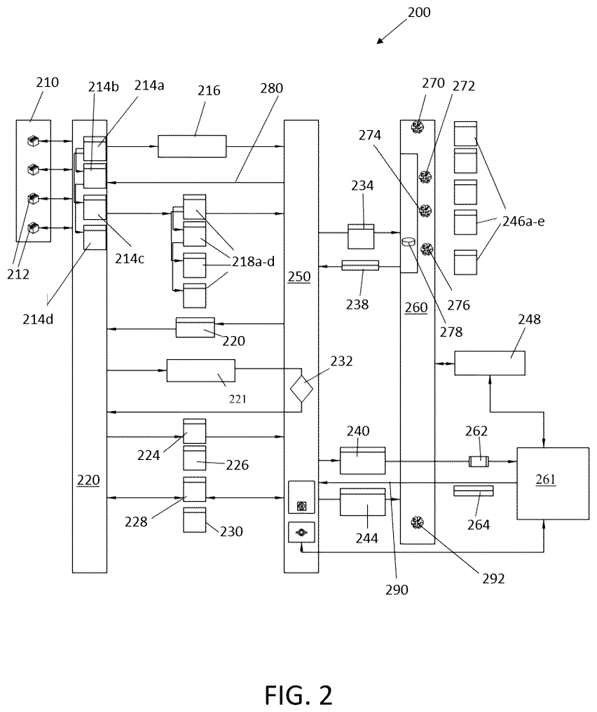

FIG. 2 shows an AI recruitment system 200 and illustrates a comprehensive, standalone Artificial Intelligence Recruiter (AIR) Pipeline system. The AI recruitment system automates and optimizes the recruitment process using advanced data processing and machine learning techniques. The pipeline consists of several components and processes including Domain Model Messaging Layer, Data Flow and Webhooks, Structured AIR Microservice Layer, AI/ML Processing Components, Matching and Scoring System, Call Transcription and Scoring, Conversational Summarization Service, Final Processing and Output, Data Storage and Management, and Integration and Scalability.

The pipeline begins with a domain model messaging layer 220, which serves as the input interface for the system. The domain model messaging layer 220 comprises several data entities including, Application 214a, Candidate 214b, Job 214c, and Attachment 214d. A module 210 is provided for storage 212 for each of the Application 214a, Candidate 214b, Job 214c, and Attachment 214d entities These entities represent the core information units processed by the system, containing details about job applications, candidate profiles, job descriptions, and supplementary documents. The system employs webhooks and payload requests to initiate and manage data flow. The application created webhook 216 triggers the pipeline when a new application is submitted. A job request payload handles job-related data transmission. A structured AIR microservice layer 250 is a central component of the system, responsible for structured processing of the input data. The structured AIR microservice layer includes several microservices that handle specific aspects of the recruitment process. AI/ML Processing Components include multiple AI and machine learning models 270, 272 which are integrated into the pipeline. These components include Job Title Predictor, Resume Parser, Skill Extractor, and Previous Company Extractor. Each of these AI models performs specialized tasks on the input data, extracting relevant information and making predictions to assist in the recruitment process. The pipeline incorporates a sophisticated matching and scoring system which initiates the process of evaluating candidates against job requirements. A match score response is generated which returns the results of the matching process. The system uses AI algorithms to assess the compatibility between candidates and job openings. Candidate activity information 221 is provided to messaging layer 220 from AIR microservice layer 250. The application current stage 222 is updated and in the AIR microservice layer 250 a check 232 is made of the current stage. If the current stage is the AI interview, it is routed back to messaging domain 220. The domain model messaging layer 220 and the AIR microservice layer 250 share data including, Application 224, Candidate 226, Job 228, and Attachment 230 information.

The pipeline is able to process audio data whereby call recordings are transcribed into text and the transcribed calls are then scored to evaluate candidate responses or interview performance. A conversational summarization service provides advanced natural language processing capability, used to summarize interviews or interactions with candidates. The conversational summarization service extracts key points from lengthy conversations or documents. The pipeline concludes with the final stages including generation of a final payload 261 which includes all processed and analyzed data about the candidate. The AIR interview is complete and marks the end of the automated interview and analysis process. Data Storage and Management—The system incorporates robust data storage solutions to manage the large volume of information processed throughout the pipeline. The modular nature of the pipeline ensures high scalability and seamless integration with existing HR systems and databases. The AI Recruiter Pipeline represents a sophisticated, end-to-end solution for automating and enhancing the recruitment process, leveraging cutting-edge AI and data processing technologies to streamline candidate evaluation and selection.

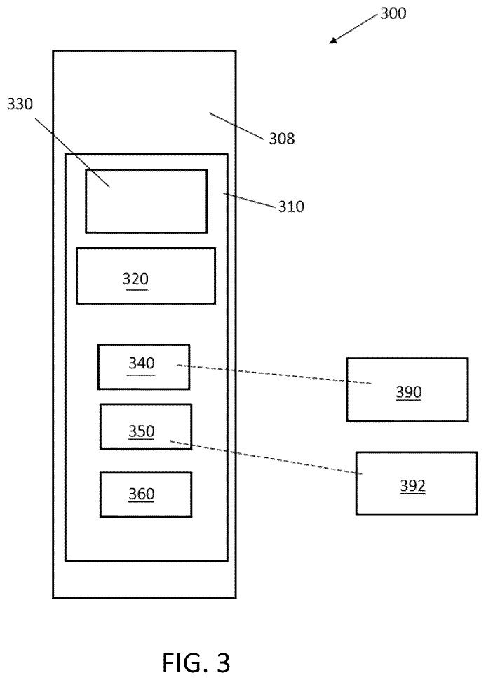

As shown in FIG. 3, a talent recruitment system 300 includes a computing system 308 and a recruitment application 310 running on the computing system 308, the recruitment application 310 including instructions or software 320 and a knowledge base 330. The talent recruitment system 300 includes a first AI module 340 for generating a job description wherein the first AI module 340 leverages a Large Language Model 390 trained on a proprietary dataset of successful job descriptions. The talent recruitment system 300 includes a sourcing module 350 for automated candidate sourcing wherein the sourcing module 350 includes use of an AI-driven engine 392 leveraging a global database of candidate profiles. The talent recruitment system 300 includes a screening module 360 for AI-Enhanced resume screening wherein the screening module screens and ranks resumes by applying consistent criteria in relation to the job requirements.

The first AI module has been benchmarked through evaluation metrics analysis on historical job descriptions and human grading to ensure the relevance and accuracy of the generated job postings and by utilizing historical offer data, the system suggests rates that align with market trends, considering factors such as location, role, years of experience, and skill.

The sourcing module may apply a hybrid filtering approach, combining rule-based systems with machine learning classifiers wherein the AI-driven engine ranks candidates according to their alignment with the job description, considering factors such as skills, experience, and previous job performance resulting in a significant reduction in the time needed to identify suitable candidates.

The screening and ranking of resumes may apply consistent criteria in relation to the job requirements using a combination of keyword analysis, semantic matching, and machine learning to evaluate the relevance of a profile of each candidate.

The clients may receive a match label indicating a great or poor fit and receive a concise summary in natural language, outlining the key factors that contribute to the candidate's suitability for the role wherein the system ensures that the most qualified candidates are prioritized, reducing the potential for human bias and improving the overall quality of hires.

The system may perform synchronous live video interviews or live audio interviews, the system including an interview module using a marketplace large language model trained with proprietary data from the a marketplace using the system, the system actively understanding and interacting with the applicant in real-time, wherein the marketplace large language model processes responses of the applicant, assesses relevance and depth, and formulates follow-up questions dynamically, wherein the interaction between the applicant and the interview module allows the system to focus on specific areas of expertise of the candidate, ensuring a comprehensive evaluation of the applicant capabilities and wherein the line of questioning is continuously adjusted based on the applicant answers, enabling a thorough assessment of their skills, experience, and fit for the role. The system may ensure every candidate is assessed comprehensively, reducing the risk of overlooking critical competencies and providing hiring. The system may include use of managers with a detailed and nuanced profile of each candidate. The data-driven insights may include detailed analytics on various aspects of the recruitment process, including the applicant's skills, work history, and alignment with the client's role requirements. It collects and analyzes data such as applicant Skills: including specific technical and soft skills of candidates, derived from their resumes, profiles, and interview responses. The data-driven insights may include work history including the applicant's previous roles, duration of employment, and career progression, providing insights into their experience and suitability for the position. The data-driven insights may include client requirements including specific qualifications, skills, and experience required by the client for the role, ensuring that candidates are matched with positions that align with their expertise. The insights may help organizations refine their hiring strategies, optimize role descriptions, and make more informed decisions, ultimately improving the overall efficiency and effectiveness of the recruitment process.

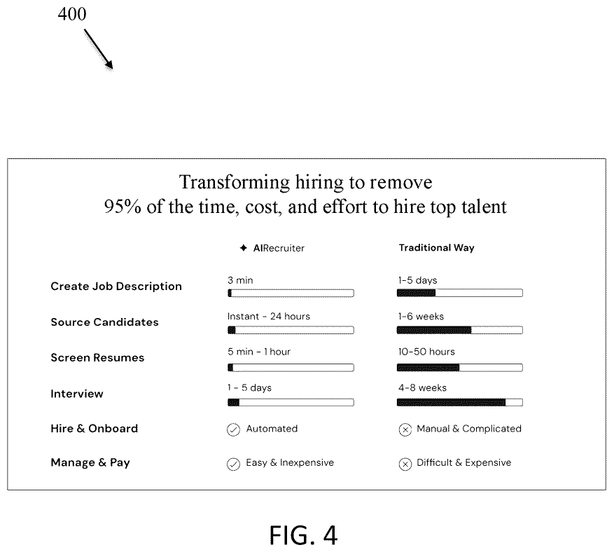

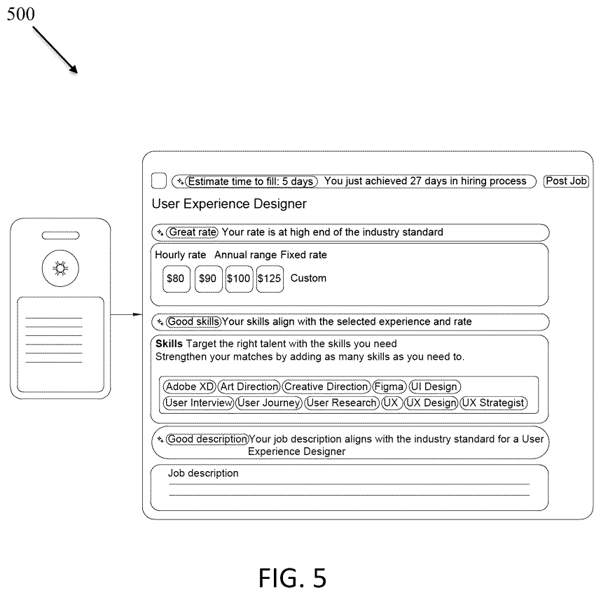

FIGS. 4 and 5 are slides 400, 500 showing the first steps in using the automated talent acquisition and management system. The system includes an artificial intelligence (AI) ingesting agent for ingesting data sets about companies and candidates. The system includes an AI description agent for generating custom job descriptions based on the ingested data about a company, an AI sourcing agent for sourcing candidates for a new job based on the generated job descriptions and an AI screening agent configured to screen resumes, profiles, conduct live interviews, and build candidate scorecards.

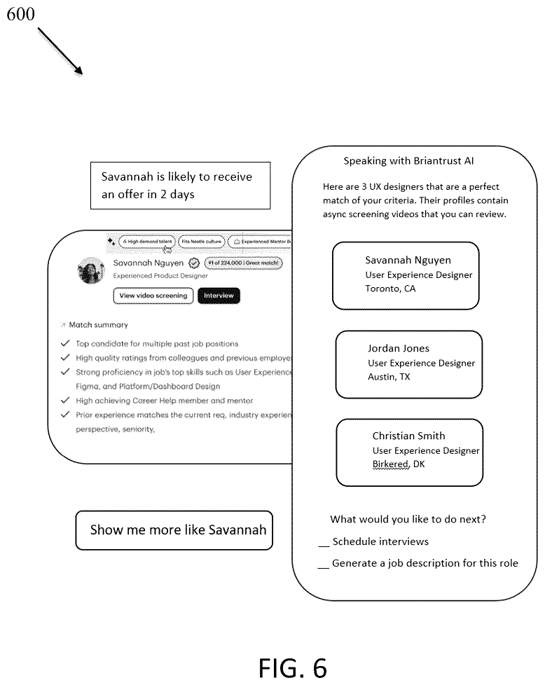

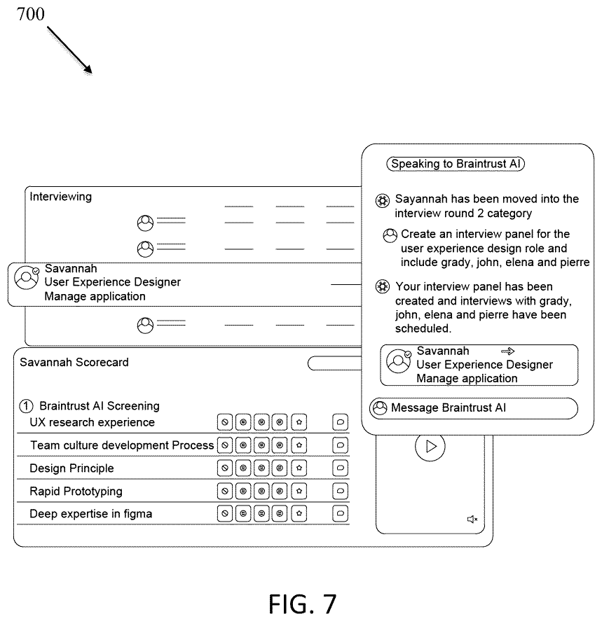

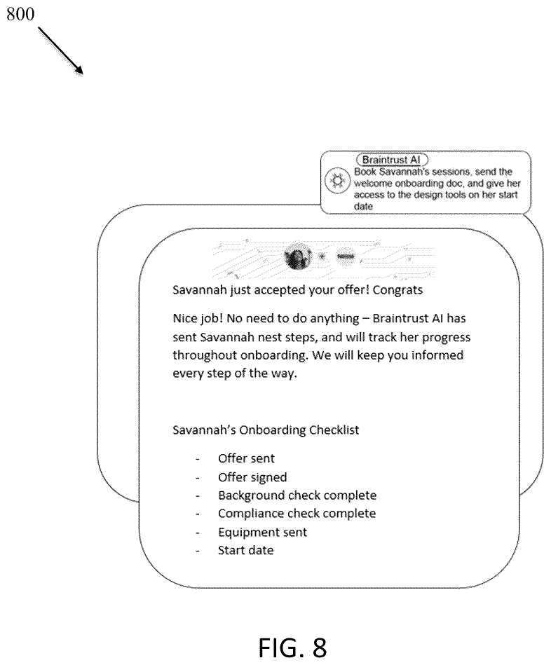

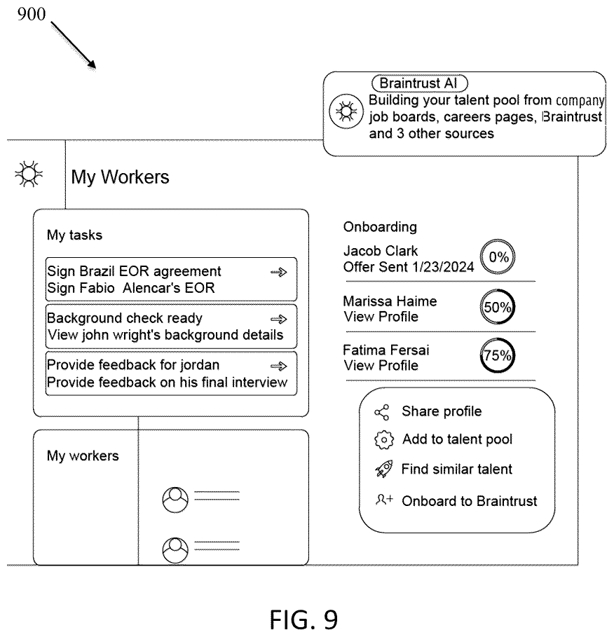

FIG. 6 is a slide 600 showing the step of matching of candidates wherein the AI matching system matches candidates to jobs based on hundreds of input parameters. The software system manages paying employees and contractors. The AI ingesting agent ingests data sets about companies and candidates, learns and adapts based on the ingested data and generates custom job descriptions. The AI description agent updates the job descriptions based on changes in the company's requirements. The AI sourcing agent sources candidates for a new job and sources candidates from multiple platforms and to screen resumes, profiles, conduct live interviews, and build candidate scorecards is further configured to provide real-time feedback to the candidates. The AI matching system is configured to match candidates to jobs and to provide a ranking of the candidates based on the match. The software system manages paying employees and contractors is further configured to handle tax and benefits calculations. FIG. 7 is a slide 700 showing the step of interviewing the talent using the system. The system conducts the first interview using a proprietary set of questions or a set of questions by the user. The system fills out the scorecard and presents the results. The system automatically advances candidates and schedules the next set of interviews. The hiring manager reviews the candidate scorecards and video interviews asynchronously. The hiring manager edits and shares recorded interviews and scorecards. FIG. 8 is a slide 800 showing the generation of offers using the system. The hiring manager alerts the system that the hiring manager is ready to hire. The system generated an offer and send the required paperwork to the candidate. The system triggers background and compliance checks and any custom steps to prepare candidate hire for the first day. The onboarding process begins. FIG. 9 is a slide 900 showing an overall view of the system. The system includes a single platform to manage and pay all the global talent. The system builds and organizes custom talent pools and automatically alerts the user with upcoming task. Since AI is implemented, the system gets smarter the more it is used. The system allows the hiring manager to build custom talent pools and to easily manage all the talent progress, statuses and paperwork. The hiring manager can invite users as needed using custom user settings.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above-described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A talent recruitment system comprising:
a computing system;
a recruitment application running on the computing system, the recruitment application including software and a knowledge base,
a first AI module for generating a job description wherein the first AI module leverages a Large Language Model trained on a proprietary dataset of successful job descriptions;
a sourcing module for automated candidate sourcing wherein the sourcing module includes use of an AI-driven engine leveraging a global database of candidate profiles; and
a screening module for AI-Enhanced resume screening wherein the screening module screens and ranks resumes by applying consistent criteria in relation to the job requirements.

2. The talent recruitment system of claim 1 wherein the first AI module has been benchmarked through evaluation metrics analysis on historical job descriptions and human grading to ensure the relevance and accuracy of the generated job postings and by utilizing historical offer data, the system suggests rates that align with market trends, considering factors such as location, role, years of experience, and skill.

3. The talent recruitment system of claim 1 wherein the sourcing module applies a hybrid filtering approach, combining rule-based systems with machine learning classifiers wherein the AI-driven engine ranks candidates according to their alignment with the job description, considering factors such as skills, experience, and previous job performance resulting in a significant reduction in the time needed to identify suitable candidates.

4. The talent recruitment system of claim 1 wherein the screening and ranking of resumes applies consistent criteria in relation to the job requirements using a combination of keyword analysis, semantic matching, and machine learning to evaluate the relevance of a profile of each candidate.

5. The talent recruitment system of claim 1 wherein clients receive a match label indicating a great or poor fit and receive a concise summary in natural language, outlining the key factors that contribute to the candidate's suitability for the role wherein the system ensures that the most qualified candidates are prioritized, reducing the potential for human bias and improving the overall quality of hires.

6. The talent recruitment system of claim 1 wherein the system performs synchronous live video interviews or live audio interviews, the system including an interview module using a marketplace large language model trained with proprietary data from the a marketplace using the system, the system actively understanding and interacting with the applicant in real-time, wherein the marketplace large language model processes responses of the applicant, assesses relevance and depth, and formulates follow-up questions dynamically, wherein the interaction between the applicant and the interview module allows the system to focus on specific areas of expertise of the candidate, ensuring a comprehensive evaluation of the applicant capabilities and wherein the line of questioning is continuously adjusted based on the applicant answers, enabling a thorough assessment of their skills, experience, and fit for the role.

7. The talent recruitment system of claim 1 wherein the system ensures every candidate is assessed comprehensively, reducing the risk of overlooking critical competencies and providing hiring.

8. The talent recruitment system of claim 1 including managers having a detailed and nuanced profile of each candidate.

9. The talent recruitment system of claim 1 wherein data-driven insights include;
detailed analytics on various aspects of the recruitment process, including the applicant's skills, work history, and alignment with the client's role requirements. It collects and analyzes data such as applicant Skills: including specific technical and soft skills of candidates, derived from their resumes, profiles, and interview responses;
work history including the applicant's previous roles, duration of employment, and career progression, providing insights into their experience and suitability for the position; and
client requirements including specific qualifications, skills, and experience required by the client for the role, ensuring that candidates are matched with positions that align with their expertise.

10. The talent recruitment system of claim 1 wherein the insights help organizations refine their hiring strategies, optimize role descriptions, and make more informed decisions, ultimately improving the overall efficiency and effectiveness of the recruitment process.

11. A method of job recruiting, the method comprising:
providing a computer-based system having a first AI module for generating a job description, a sourcing module for automated candidate sourcing and a screening module for AI-Enhanced resume screening;
an applicant installing an application on a personal computing device for registering with the system by entering registration information to a computer-based system containing a database;
the database issuing an applicant identifier identification device viewable using the application on the personal computing device;
the computer-based system containing the database storing the registration information and the applicant identifier identification device to form a record identified by the applicant identifier identification device on the database;
wherein the first AI module for generating a job description wherein the first AI module leverages a Large Language Model trained on a proprietary dataset of successful job descriptions;
wherein the sourcing module includes use of an AI-driven engine leveraging a global database of candidate profiles; and
wherein the screening module screens and ranks resumes by applying consistent criteria in relation to the job requirements.
